(19) United States
(12) Patent Application Publication
(10) Pub. No.: US 2015/0152321 A1
(43) Pub. Date: Jun. 4, 2015

(54) HETEROGENEOUS PROPPANT PLACEMENT

(71) Applicant: Schlumberger Technology Corporation, Sugar Land, TX (US)

(72) Inventors: Zinaida Yurievna Usova, Sugar Land, TX (US); Anna Petrovna Dunaeva, Houston, TX (US); Mohan K.R. Panga, Sugar Land, TX (US); Anatoly Vladimirovich Medvedev, Moscow (RU); Sergey Makarychev-Mikhailov, Richmond, TX (US); Evgeny Borisovich Barmatov, Cambridge (GB); Trevor Lloyd Hughes, Cambridge (GB)

(21) Appl. No.: 14/620,979

(22) Filed: Feb. 12, 2015

Related U.S. Application Data
(63) Continuation-in-part of application No. 13/642,557, filed on Nov. 15, 2012.

(51) Int. Cl. C09K 8/80; E21B 43/24; E21B 43/267

(52) U.S. Cl. CPC C09K 8/80; E21B 43/267; E21B 43/2405; C09K 2208/08

(57) ABSTRACT

A method for forming proppant aggregates, for example downhole in an injection well, includes injecting a slurry including a thermo-responsive polymer with a low critical solution temperature and a proppant downhole, and heating the slurry above the low critical solution temperature of the polymer. The heating of the slurry above the low critical solution temperature of the polymer aggregates the proppant. A composition of the slurry includes a carrier fluid including a thermo-responsive polymer, a proppant, and optional additives.

### PRIORITY

This is a Continuation-in-Part of application Ser. No. 13/642,557 filed Nov. 15, 2012, which in turn is a National Phase application of PCT/RU10/00207 filed Apr. 27, 2010. The disclosures of each of the prior applications are hereby incorporated by reference herein in its entirety.

### BACKGROUND

The present disclosure relates to reservoir stimulation by hydraulic fracturing. More particularly it relates to methods of heterogeneous proppant placement (HPP) in fractures, which increases their conductivity and enhances fluid production. The HPP is achieved by formation of proppant clusters in situ in the fracture due to polymer gel phase transitions or polymer gel chemical transformations.

There is a need for a method of inducing heterogeneous proppant placement in subterranean formation hydraulic fractures that does not require large changes in injected slurry proppant concentration or viscosity.

### BRIEF SUMMARY

One embodiment of the disclosure is a method of inducing proppant aggregation in a hydraulic fracture including the steps of (1) formulating a proppant carrier fluid viscosified by a first polymer gel that can undergo syneresis; (2) injecting a slurry of the fluid and proppant; and (3) triggering gel syneresis. The fluid may contain fibers and at least a portion of the proppant may be resin coated.

In one version of this embodiment, the polymer gel is crosslinked, for example the gel is a borate crosslinked polymer gel, and the syneresis is triggered by incorporation of a multivalent cation in the gel. The multivalent cation is a cation of a metal selected for example from Ca, Zn, Al, Fe, Cu, Co, Cr, Ni, Ti, Zr and mixtures of these. The cation is incorporated for example by dissolution or by slow dissolution, for example of a salt, an oxide or a hydroxide of the cation. The cation may optionally be in the form of a hydroxide or an in situ formed hydroxide when it causes the syneresis.

In another version of this embodiment, the syneresis is caused by overcrosslinking. The overcrosslinking may be delayed for example by a crosslink delay agent, or may be induced for example by an encapsulated crosslinker, a slowly dissolvable crosslinker, or a temperature-activated crosslinker.

In yet another version of this embodiment, the syneresis is caused by including in the fluid, in addition to the polymer in the first polymer gel, a second polymer and a delayed crosslinker for the second polymer. The second polymer is optionally at a concentration below its overlap concentration.

In further versions of this embodiment, the syneresis is caused by a superabsorbent polymer or is triggered by a second fluid that contacts the proppant carrier fluid downhole.

Another embodiment of the method of inducing proppant aggregation in a hydraulic fracture includes the steps of (1) formulating a proppant carrier fluid containing (i) at least one anionic polyelectrolyte or the precursor to at least one anionic polyelectrolyte, and (ii) at least one cationic polyelectrolyte or the precursor to at least one cationic polyelectrolyte; (2) injecting a slurry of the fluid and proppant; and (3) triggering formation of a polyelectrolyte complex. The fluid may optionally contain fibers, and at least a portion of the proppant may be resin coated.

In various versions of this embodiment, the formation of the polyelectrolyte complex is induced by a pH change; the formation of the polyelectrolyte complex is induced by conversion of at least one polyelectrolyte precursor to a polyelectrolyte; the formation of the polyelectrolyte complex is induced by formation of a cationic polyelectrolyte downhole; the cationic polyelectrolyte is formed downhole by a Mannich reaction or a Hofmann degradation of a polyacrylamide; the formation of the polyelectrolyte complex is induced by formation of an anionic polyelectrolyte downhole; the anionic polyelectrolyte is formed downhole by hydrolysis; at least one polyelectrolyte or polyelectrolyte precursor is initially present in the fluid in the internal phase of an emulsion; at least one polyelectrolyte or polyelectrolyte precursor is initially present in solid form; the formation of the polyelectrolyte complex is delayed by incorporating at least one polyelectrolyte in the fluid as a polyelectrolyte-surfactant complex; and the triggering is caused by a second fluid that contacts the proppant carrier fluid downhole.

Yet another embodiment is a method of inducing proppant aggregation in a hydraulic fracture including the steps of (1) formulating a proppant carrier fluid containing a polymer below its lower critical solution temperature; and (2) injecting a slurry of the fluid and proppant into a subterranean formation that is above the lower polymer critical solution temperature. The fluid may optionally contain fibers, and at least a portion of the proppant may be resin coated.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

FIG. 1 shows the dependency of syneresis vs. time for borate crosslinked guar gel samples having different concentrations of Ca(OH)₂ at room temperature.

FIG. 2 shows the syneresis of borate crosslinked guar gels in samples having different concentrations of Mg(OH)₂ at room temperature.

FIG. 3 shows the syneresis of the borate crosslinked gel samples having varying concentrations of AlCl_{3*}6H₂O.

FIG. 4 shows various methods for the formation of PECs.

FIG. 5 shows a representation of the aggregation mechanism of proppants using polymers having LCST behavior

### DETAILED DESCRIPTION

At the outset, it should be noted that in the development of any such actual embodiment, numerous implementation-specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, even if a specific data points within the range, or even no data points within the range, are explicitly identified or refer to a few specific, it is to be understood that inventors appreciate and understand that any conceivable data point within the range is to be considered to have been specified, and that inventors possessed knowledge of the entire range and each conceivable point and sub-range within the range.

Although the following discussion emphasizes fracturing, the polymer gel phase transitions and polymer gel chemical transformations of the disclosure may be used in fracturing, gravel packing, and combined fracturing and gravel packing in a single operation. The embodiments will be described in terms of treatment of vertical wells, but is equally applicable to wells of any orientation. The embodiments will be described for hydrocarbon production wells, but it is to be understood that the embodiments may be used for wells for production of other fluids, such as water or carbon dioxide, or, for example, for injection or storage wells.

While hydraulic fracturing is currently one of the most important and widely used methods of reservoir stimulation, it is still not free from serious fundamental limitations, which can restrict hydrocarbon production. Conventional stimulation jobs involve pumping a viscosified fluid downhole at a rate and pressure sufficient to fracture the formation; the resulting fracture is filled with a proppant material may be delivered into the fracture with the same fluid. The proppant is intended to prevent fracture closure and may be sand or a ceramic. The packed proppant bed provides hydraulic conductivity orders of magnitude higher than that of the formation, thus, allowing enhanced fluid flow towards a wellbore. However, despite significant efforts focused on the development of new proppant materials with optimized properties (high crush resistance, low density and cost), the achievable permeability (conductivity) of conventionally propped fractures can still be a limiting factor for fluid production.

Heterogeneous proppant placement (HPP), for example placement of proppant in a fracture as consolidated clusters (for example pillars) thus creating open channels in the fracture, can drastically improve fracture conductivity above the limits of conventional proppant packs. In contrast to an approach in which proppant placement mainly relies on a special pumping schedule, the present embodiment encompasses a family of HPP methods in which proppant clusters, e.g. agglomerates or aggregates, are generated in situ in the fracture, and cluster formation timing and location are controlled by chemical means through polymer gel phase transitions or chemical transformations.

In one embodiment, a polymer gel used as the viscosifier of a fracturing fluid is deliberately subjected to syneresis. This process may be considered highly undesirable, as it drastically affects rheological properties of the fracturing fluid, and special efforts are often undertaken to avoid or diminish it. However, if properly controlled, syneresis with expulsion of water from the gel can lead to proppant particle aggregation. The resulting polymer clots entrap and retain proppant inside them; the distance between particulates in the clots is smaller, for example, significantly smaller than in the original homogeneous slurry. The proppant aggregates (clusters) keeping the fracture from closure provide channels in between them and, thus, enhanced, for example, significantly enhanced fracture conductivity.

In another embodiment, the polymer clots are formed due to interactions between two different polymers, triggered chemically. An example is the formation of complexes between two oppositely charged polyelectrolytes. The complex formation is accompanied by aggregation of proppant particulates and consequently HPP. In yet another embodiment, the proppant aggregation into clusters takes place due to a phase transition in a polymer solution. A polymer solution with a low critical solution temperature (LCST) undergoes phase separation at bottomhole temperature and the resulting polymer precipitate consolidates proppant particles.

The proppant aggregates formed by the method described herein can further be reinforced by resin curing, with fibers, or by other means known in the art.

The present disclosure discloses a method of heterogeneous proppant cluster formation by utilizing gel phase transitions and chemical transformations that lead to proppant aggregation.

Formation of heterogeneous proppant structures by the method described herein may be controlled by syneresis of the fracturing gel. Syneresis is defined herein as a process of water expulsion from a gel. Syneresis leads to a phase separation in the gel and to formation of a water phase caused by the collapse of the gel. When the gel contains proppant particles, the syneresis leads to proppant aggregation, which generally depends upon the degree of gel shrinkage. In the present disclosure the syneresis can be controlled by various means.

One method of causing and controlling syneresis is the use of borate-crosslinked polymer gels and multivalent cations. It is believed that this works with Ti and Zr-crosslinked gels as well. For example, the addition of calcium hydroxide to a borate-crosslinked gel causes syneresis. For example, calcium chloride, borate, and polymer are mixed at the surface. A hydroxide, or a delayed source of hydroxide such as magnesium oxide to generate the calcium hydroxide in situ, is added. Syneresis occurs after sufficient multivalent cation hydroxide is present. Generally, the more calcium ion present, the greater and faster the syneresis. Other multivalent cations may be used, for example Zn, Al, Mg, Fe, Cu, Cr, Co, Ti, Zr, and/or Ni. The level of syneresis may depend not only on the multivalent ion concentration, but also on the borate crosslinking density. It should be noted that an inexpensive and/or unmodified guar may be used because the function may not be to provide viscosity and because impurities are not a problem if they end up in the agglomerated proppant.

Yet one more method of causing and controlling syneresis is to use gel overcrosslinking. It is well known in the industry that high crosslinker concentration can lead to an increased density of crosslinked sites and finally to gel collapse, which is why special precautions are often undertaken to avoid overcrosslinking. However, in the present embodiment, controlled syneresis is promoted by the use of at least one crosslinker and/or at least one crosslinking delaying mechanism. Having more than one crosslinker and/or delaying mechanism allows initial pumping of a slurry having a conventional viscosity with a desirable degree of crosslinking, ensuring good proppant transport deep into a fracture. The gel overcrosslinking takes place in the fracture and is induced by either a crosslinking system different from the system active during initial pumping or by additional delaying mechanism, or by both. Crosslink delay agents, which are known to those skilled in the art; examples include polyols, encapsulated crosslinkers, slowly dissolvable crosslinkers, and pH controlled and/or temperature-activated crosslinkers. Slowly dissolvable crosslinkers can be used in a pure form or can be deposited/impregnated onto/into proppant particles. Various crosslinking systems can be used according to the present embodiment, based on boron, any metal-based crosslinker systems known from the art (such as zirconium, chromium, iron, boron, aluminum, and titanium), and also based on organic compounds (such as aldehydes, dialdehydes, phenolic-aldehyde compositions, multifunctional amines and imines). In, for example, all cases, a slow crosslinker concentration increase in the gel leads to controlled gel overcrosslinking and syneresis. The size of the resulting gel aggregates (clots) is controlled by shear history, gel composition and environment conditions.

Another method of syneresis control is the use of selective crosslinking. In a mixture of crosslinkable and non-crosslinkable polymers, in which the non-crosslinkable polymer is a viscosifier, and in which crosslinkable polymer is present at a concentration below its overlap concentration, when the crosslinkable polymer crosslinks it forms what are commonly known as “microgels” (i.e. gel pieces which cannot overlap to fill space). These would form inside a viscous matrix of the non-crosslinkable polymer. Optionally, a mixture of two polymers and two crosslinkers may be used, in which each crosslinker crosslinks, for example, only one of the polymers. One polymer/crosslinker combination viscosifies the fluid and the other polymer/crosslinker combination forms a microgel. Optionally the viscosifying polymer may be crosslinked for normal fracturing purposes and later the microgels could be formed to induce proppant heterogeneity. Examples include (1) matrix polymer=guar/borate+microgel polymer=xanthan/Cr³⁺ (delayed) or (2) matrix polymer=guar/borate+microgel polymer=polyacrylamide/Cr³⁺ (delayed) or polyacrylamide formaldehyde (delayed for example using hexamethylenetetramine).

Another method of syneresis control is the use of polymer mixtures. Such a mixture may include similar-type polymers (for example different polysaccharides such as non-derivatized guar and carboxymethyl hydroxyethyl guar) or different-type polymers (for example polysaccharides and polyacrylamides). The crosslinking systems may be, as examples, any of those mentioned above. Differing affinities to the crosslinker of different polymers lead to formation of gel volumes having different viscosities. The size and distribution of the volumes can be controlled by solution composition, mixing efficiency, and polymer properties.

Yet another method of gel syneresis control is utilization of superabsorbent polymers (SAPs) to cause water extraction from a crosslinked gel. The molecular weight and chemical properties of SAPs can be adjusted in such a way as to cause osmotic pressure to move water from the gel phase into the SAP phase. Loss of water by the gel leads to proppant particle aggregation. Superabsorbent polymers may be added to a slurry in a dry state or in partially swollen state. The degree of swelling and the choice of the solvent used with the SAP can be used for control of competitive swelling of the gel and the SAP. Furthermore, the absorbance of water by a superabsorbent can be triggered by pH, solution/gel ionic strength, temperature and by other factors. SAP molecules can be either crosslinked or not.

Yet another method of controlling syneresis is the addition of fibers, for example polylactic acid fibers, to any of the systems mentioned above. Fibers may not affect the degree of syneresis but they do control the volume occupied by the shrunken gel. For example, the more fibers used, the greater the final volume of the gel phase at the same degree of syneresis. In addition, the presence of fibers may change, for example, greatly change the mechanical properties of the gel phase.

Polyelectrolyte solutions are widely used in various oilfield technologies, may provide a unique combination of properties. Carboxymethylated guars and celluloses (such as carboxymethyl guar, (CMG), carboxymethyl hydroxypropyl guar (CMHPG), carboxymethyl cellulose (CMC), polyanionic cellulose (PAC), carboxymethyl hydroxyethyl cellulose (CMHEC), etc.) are the most common such polymers used in drilling fluids and fracturing gels. These derivatized polysaccharides have polar carboxylic groups, making the polymers more water soluble, chemically resistant and crosslinkable with metals. Many natural and semi-synthetic polymers are also polyanions, such as xanthan, carrageenan, lignosulfonate, etc. Among purely synthetic polyanions, the polymers based on polyacrylic acid (PA) and polyacrylamide (PAM) may be used. They are utilized as flocculants, dewatering agents, and friction reducers and have many other applications. The PAMs contain anionic groups due either to intrinsic hydrolysis of acrylamide to acrylic acid, or due to deliberately incorporated sulfonic groups (e.g. acrylamido-2-methyl-1-propane sulfonic acid, (AMPS). Complexes of guar with borate ion show polyanionic properties in basic environments.

Polycations are used less often in oilfield technologies, as they may be more expensive than their anionic counterparts. Examples of the most common polycations include different polyacrylamide copolymers with diallyldimethylammonium chloride (DADMAC), acryloyloxyethyltrimethylammonium chloride (AETAC) and other quaternary ammonium monomers, polyvinyl pyrrolidone (PVP), polyethyleneimine (PEI) and natural polymers, such as chitosan, gelatin (and other polypeptides), and poly-L-lysine.

The interaction of polyelectrolytes of opposite charge in solution results in aggregation and formation of a polyelectrolyte complex (PEC). Upon PEC formation, small counterions localized near charged groups of free polyelectrolytes are released, resulting in a gain in entropy, which is considered to be the main driving force of the interaction as shown below. Long chain polyanions and polycations, each with their small organic or inorganic counterions, form complexes of the polymers in which they serve as one another‘s’ counterions and the original small counterions are no longer included in the complexes. Other effects may also contribute, including formation of interpolymer hydrogen bonds, hydrophobic interactions, etc.

Many PEC structures are available. One is based on the formation of nearly stoichiometric complexes between polyelectrolytes of similar molecular weights; this may be called a “ladder”-type complex, in which oppositely charged polymeric chains are aligned and linked ionically (as shown in route A, FIG. 4). Water-soluble, ordered, non-stoichiometric complexes with the ladder-type structure are also known. In more disordered PECs, the structure of which has been referred to as “scrambled egg”-type, the polymer chains coil, forming a structure with statistical charge compensation (as shown in route B, FIG. 4). Such complexes often have highly non-stoichiometric ratios of polyelectrolytes and may be characterized by very low solubility. Utilization of these complexes is one of the embodiments of the present disclosure.

Formation of PECs with the scrambled egg structure allows entrapment of proppant particulates in the clots. It should be mentioned that the aggregation forces holding the particles in clusters are much stronger than in the case of flocculation. Flocculation is widely used in water treatment; particles subjected to flocculation have sizes generally not exceeding about 150 microns (100 US mesh). Organic flocculants, which may include water-soluble polymers, provide molecular interlinks between the particles, so the resulting flocs are held by coiled, yet linear, polymer chains. In contrast, PEC clots represent highly crosslinked 3D networks of polymer chains, which may, additionally, as in the case of flocculants, have an affinity to the surfaces of entrapped particles due to electrostatic, van der Waals, hydrogen bonding and other forces.

The formation of PECs can be controlled in a variety of ways. pH delaying agents, known to those skilled in art, can be used to adjust the pH of a fracturing fluid and initiate PEC formation in a fracture. In a non-limiting example, the fracturing slurry, in addition to proppant and other additives, is made from two polyacrylamide copolymers, the first of which is made with acrylic acid as one monomer and the second of which is made with DADMAC as one monomer. When the slurry pH is kept below about 4.0, most of carboxylic groups of PAM-PA (polymer of acrylamide and acrylic acid) exist in a non-dissociated (protonated) form and the PAM-PA polymer does not exhibit any polyelectrolyte properties. Once the slurry pH is raised above about 5.0, carboxylic acid groups start dissociating and the resulting PAM-PA polyelectrolyte undergoes complexation with the PAM-DADMAC, forming low soluble PEC clots with entrapped proppant particles.

Another method of controlling PEC formation is in situ synthesis of one polyelectrolyte downhole. In a non-limiting example, the Mannich aminomethylation or Hofmann degradation reactions of polyacrylamide polymer are used to produce polycationic species from initially neutral PAM. Both reactions proceed in aqueous solutions at temperatures above about 50° C. In the Mannich reaction, a PAM is treated with formaldehyde and an amine which results in formation of Mannich base groups (—NH—CH₂—NR₂), which are positively charged even in solutions with relatively high pH values; the product is a polycation. Secondary amines, for example diethyl and dipropylamine may be used, but ammonia and primary amines may also be used. Formaldehyde can be obtained downhole from a precursor (for example urotropin (hexamethylenetetramine)), so no toxic substances are needed at a wellsite. Another method of generating a polyelectrolyte downhole is the Hofmann degradation reaction, in which a PAM is treated with hypohalogenites in alkaline solution, which leads to polyvinylamine, a cationic polyelectrolyte. Details of chemical transformations of PAMs under downhole conditions can be found in co-filed patent application “Subterranean Reservoir Treatment Method” invented by Makarychev-Mikhailov, and Khlestkin.

Yet another method of controlling (delaying) PEC formation is the utilization of any type of emulsion (oil-in-water, water-in-oil, water-in-water) to transport at least one polyelectrolyte downhole. In a non-limiting example, a fracturing slurry, in addition to proppant and other additives, contains emulsion droplets, stable at ambient conditions, which confine a polyelectrolyte, which therefore is non-reactive towards its oppositely charged counterpart, also present in the slurry. The emulsion breaks either under downhole conditions (at elevated temperature) or by means of a delayed emulsion breaker, releasing the polyelectrolyte, which participates, for example, immediately participates in a PEC formation reaction.

Yet another method of utilizing PEC's is to add one of the polymers or polymer precursors in solid form.

Any other methods of controlled (delayed) PEC formation may be used, for example based on temporary protection of the charged groups of at least one of the polyelectrolytes by means of chemical protection groups or surfactants (by using polyelectrolyte-surfactant complexes).

Other non-limiting examples of pH triggering that may be used to initiate PEC formation include:
1. Use of a mixture containing polyethylene imine (which is non-ionic at alkaline pH) plus sulphonated polymer (in which the anionic charge persists at high, neutral and low pH); no PEC will be formed until the pH is changed from alkaline conditions to acidic conditions (whereupon the PEI becomes positively charged). Such a pH change could be triggered by controlled hydrolysis of polylactic acid and/or polyglycolic acid (PLA/PGA) particles.
2. Use of a mixture of chitosan (which is insoluble at alkaline pH) plus sulphonated polymer (in which the anionic charge persists at high, neutral and low pH); no PEC will be formed until the pH is changed from alkaline conditions to acidic conditions (wherein chitosan is dissolved as a cationic polymer). Again, such a pH change could be triggered by controlled hydrolysis of polylactic acid and/or polyglycolic acid (PLA/PGA) particles.
3. Use of a mixture of polyDADMAC (in which the cationic charge persists at high, neutral and low pH) plus a carboxylate polymer (which is anionic at high pH, but non-ionic at pH near and below the pKa). No PEC is formed under acidic conditions; the pH is raised to induce PEC formation.

Triggers other than PEC polymer complexes will lead to similar results. In addition to electrostatic interactions, other forces may be used as a driving force for polymer complex formation. As a non limiting example, complexes based on hydrogen bonding provide a function similar to that of PECs described above. In a wider sense, in the discussion above, instead of PECs any complex may be used which involves at least one polyelectrolyte. Such a polyelectrolyte can be complexed with a variety of compounds, such as non-ionic polymers, surfactants, and inorganic species (for example, metal ions).

Polymers with Low Critical Solution Temperature (LCST)

Stimulus-responsive polymers are a wide class of modern functionalized materials. They are able to perceive small changes in external signals, such as pH, temperature, electric/magnetic/mechanical field, or light, and produce corresponding changes or transformation of the physical structure and chemical properties of a polymer solution or gel. Much attention has been paid to chemical design and investigation of thermally sensitive or thermo-responsive polymers. In particular, they exhibit sensitive responses in their structure, properties, and configuration to changes in temperature. Aqueous solutions of certain polymers may undergo fast, reversible changes around their low critical solution temperature (LCST). Below the LCST, the free polymer chains may be soluble in water and exist in an extended conformation that is fully hydrated. On the contrary, above the LCST, the polymer chains may become more hydrophobic, resulting in the assembly of a phase-separated state. Thermo-responsive polymers have a variety of applications, such as temperature or pH-sensitive materials for drug delivery applications, biosensors, thermally responsive coatings, catalysis, soluble polymeric ligands for heavy metal scavenging, size selective separation and as water-dispersible hydrophobic thickening agents in the oilfield industry.

The solubility of most polymers increases with increasing temperature, but certain LCST polymers have inverse temperature dependent solubilities. Polymers bearing amide groups form the largest group of thermo-sensitive polymers. Among them, poly(N-isopropylacrylamide) (PNIPAM) and poly(N,N′-diethylacrylamide) (PDEAAM) are most well-known. They have similar LCSTs of 32-33° C. Poly(ethylene oxide) (PEO) is one of the most-studied biocompatible polymers that exhibit LCST behavior. The LCST transition of PEO aqueous solutions occurs at temperatures ranging from about 100° C. to about 150° C., depending upon the molecular weight. This temperature range extends PEO applications for temperature-sensitive purposes. The properties of a polymer solution, such as the phase transition temperature, may depend on the chemical composition and the molecular weight of the polymer and on environmental conditions such as fluid pH and ionic composition and concentration.

Examples of polymers having low critical solution temperatures includes, but is not limited to, ethylene/vinyl alcohol copolymers; ethylene oxide/propylene oxide copolymers; copolymers of N,N-dimethylacrylamide with methyl acrylate, ethyl acrylate, propyl acrylate, butyl acrylate, 2-ethoxyethyl acrylate, and/or 2-methoxyethyl acrylate; hydroxypropyl cellulose; N-isopropylacrylamide/acrylamide copolymers; copolymers of N-isopropylacrylamide with 1-deoxy-1-methacrylamido-D-glucitol; N-isopropylmethacrylamide; methylcellulose (having various concentrations of methyl substitution); methylcellulose/hydroxypropylcellulose copolymers; polyphosphazene polymers, including poly[bis(2,3-dimethoxypropanoxy)phosphazene], poly[bis(2-(2′-methoxyethoxyl)ethoxy)phosphazene], poly[bis(2,3-bis(2-methoxyethoxy) propanoxy)phosphazene], poly[bis(2,3-bis(2-(2′-methoxyethoxyl)ethoxy)propanoxy)phosphazene], and poly[bis(2,3-bis(2-(2′-(2″-dimethoxyethoxy) ethoxy)ethoxy)propanoxy)phosphazene]; poly(ethylene glycol); poly(ethylene oxide)-b-poly[bis(methoxyethoxyethoxy)-phosphazene] block copolymers; poly(ethylene oxide)-b-poly(propyleneoxide)-b-poly(ethylene oxide) triblock copolymer; poly(N-isopropylacrylamide); poly(N-isopropylacrylamide)-poly[(N-acetylimino)ethylene] block copolymers; poly(N-isopropylmethacrylamide); poly(propylene glycol); poly(vinyl alcohol); poly(N-vinyl caprolactam); poly(N-vinylisobutyramide); poly(vinyl methyl ether); poly(N-vinyl-N-propylacetamide); N-vinylacetamide/vinyl acetate copolymers; N-vinylcaprolactam/N-vinylamine copolymers; vinyl alcohol/vinyl butyrate copolymers; N-vinylformamide/vinyl acetate copolymers and combinations of these.

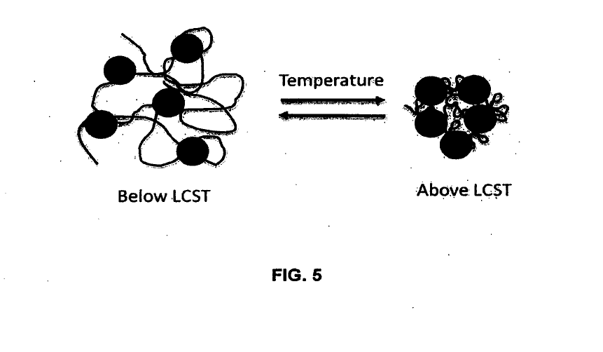

Thermo-responsive polymer flocculants can be used for aggregation of proppant particulates in a fracture. FIG. 5 shows a representation of the aggregation mechanism of proppants using polymers having LCST behavior. The mechanism of particle agglomeration includes adsorption of polymer onto the surface of particles at temperatures below the LCST. Under these conditions, polymers are soluble in water, so there is hydrogen bonding between the polymer and water molecules; the polymer chains have an extended random coil conformation. When the temperature is increased above the LCST the hydrogen bonding is weakened, resulting in phase separation of the polymer and water, whereupon the polymer chains collapse and precipitate, entrapping proppant particulates.

The formation of LCST precipitates is also a way to induce or trigger the aggregation/agglomeration of proppant. However, if the formation of LCST precipitates leaves a water-like matrix fluid, leak-off may be high, leaving, for example, only the clots and proppant in the fracture. On the other hand, LCST precipitates may be formed in a way such that the residual matrix is a high viscosity low leak-off fluid.

There are, for example, two ways of practicing the embodiments: by injecting a single composition containing a trigger or delay agent or by injecting two or more compositions which mix and react downhole.

For polyelectrolyte complex (PEC)-induced agglomeration, the treatment sequence is typically as follows: inject a pad; inject a proppant-laden slurry containing at least one polyelectrolyte already in charged form and at least one non-ionic polymer, which can be converted to a polyelectrolyte with a charge opposite to that of the first polymer by a trigger or a delay agent; allow proppant aggregation; and allow fracture closure. The concentration of the polyelectrolytes and polyelectrolyte precursors is in the range of from about 0.005 to about 5 weight percent. Suitable triggering mechanisms for PEC formation are listed above. The slurry may further contain oilfield additives, known to those skilled in the art, such as viscosifiers, surfactants, clay stabilizers, bactericides, fibers, etc.

For the syneresis embodiment of causing agglomeration, the sequence may be as follows: pump a pad stage for fracture initiation; pump proppant-laden fluid that undergoes syneresis at downhole conditions; allow agglomeration of proppant; and allow the fracture to close on the aggregates formed. In one embodiment, the fluid formulation additionally contains fibers for agglomerate stabilization and settling prevention.

For using the LCST approach to agglomeration, a possible sequence of steps is the following: pump a pad stage for fracture initiation; pump proppant-laden fluid that undergo phase transition at downhole conditions (for example upon heating to downhole temperatures); allow agglomeration of proppant; and allow the fracture to close on the aggregates formed.

For the approach of using and mixing two different fluids, agglomeration is induced by pumping a pad stage for fracture initiation followed by pumping the two fluids to the perforation region by different flow paths, for example by pumping one fluid down coiled tubing and pumping the other fluid down the annulus between the coiled tubing and the wellbore. Mixing of the two fluids, in the perforations or after the perforations, induces agglomeration of proppant. Agglomerated particles are transported to the fracture. After the treatment the fracture closes on the agglomerates.

The method described herein can be used in fractures of any size and orientation. For example, it is particularly suitable for fractures in horizontal wellbores and/or in soft formations. The agglomeration and resulting heterogeneous proppant placement should occur during the pumping or during an optional shut in period; it should occur before flowback.

The embodiments can be further understood from the following examples.

### Example 1

A linear gel slurry containing 3.6 g/I (30 lb/mgal) of guar and 406 g/I (4 ppa) of sand 0.300-0.106 mm (50/140 US) was prepared with deionized water. The gel was then crosslinked with different crosslinker concentrations (see Table 1). The crosslinker consisted of a H₃BO₃:NaOH:CaCl₂ mixture in a weight ratio of 3.1:1:1.3 in which the solids content was 50 weight percent in water. Noticeable gel collapse was observed in the sample with the highest borate concentration in 3 hours, while no change was found in the gel sample with the lowest crosslinker concentration. The volumes of water expelled from the gel sample were measured after 24 hours of storage at room temperature. It was found that after syneresis all the proppant particles remained in the gel phase, where the proppant concentration was increased up to 2 times.

TABLE 1

| | | Water phase | Proppant |
|---|---|---|---|
| Sample | Crosslinker | volume after | concentration after |
| # | added, ml | 24 hours, % | syneresis, g/L |
| 1 | 2 | 0 | 406 |
| 2 | 4 | 51 | 705 |
| 3 | 7 | 61 | 826 |
| 4 | 10 | 64 | 881 |

### Example 2

Slickwater sample 1 was prepared from a water-in-oil emulsion of anionic polyacrylamide-AMPS copolymer useful as a friction reducer at a concentration of 0.1 weight percent (1 gpt) in deionized water; about 10 mg of methylene blue dye was added to the sample. Slickwater sample 2 was prepared from a water-in-oil emulsion of cationic polyacrylamide also useful as a friction reducer at the same concentration in deionized water; about 10 mg of methyl orange was added.

In one experiment, 20 ml of sample 1 was placed in a Petri dish and 20 ml of sample 2 was added to it. The Petri dish was shaken by hand to mix the two samples. After about 1 min of shaking, a net of fine green lines started to appear and grow, which was a polyelectrolyte complex colored by the mixture of dyes. The net appeared to be sticky and its further growth with shaking resulted in the formation of a clot. In a second experiment, 4.8 g of 400-800 micron (20/40 US sieve) sand was dispersed in 20 ml of sample 1 to give a proppant concentration of about 240 g/I (2 ppa). Then 20 ml of sample 2 was slowly added to the proppant slurry and the two were thoroughly mixed. The 20/40 sand grains, originally evenly dispersed, became assembled into green aggregates.

### Example 3

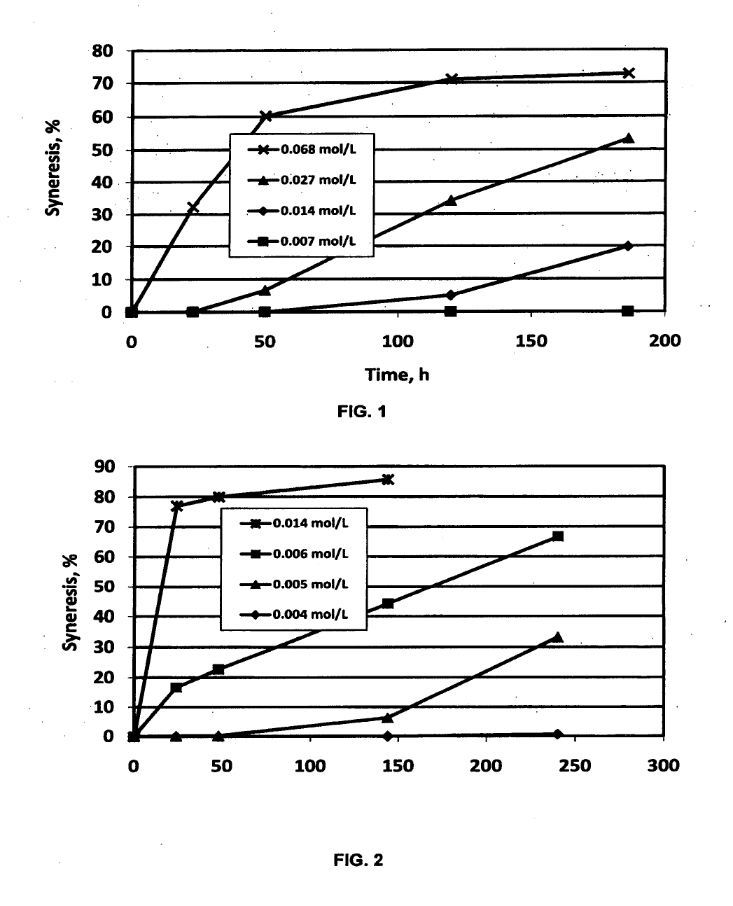

Syneresis of gels made from 3.6 g/L of guar, 0.5 g/L of boric acid, and 3 ml/L of 5 weight percent NaOH with various amounts of Ca(OH)₂ in deionized water was studied. The Ca(OH) 2 used was 0.6-0.3 mm (30/50 mesh). Syneresis that took about a day at room temperature took several hours at 50° C. The concentration of cations controlled the degree and speed of syneresis. FIG. 1 shows the dependency of syneresis vs. time for borate crosslinked guar gel samples having different concentrations of Ca(OH)₂ at room temperature. Syneresis started at about 0.014 mol/L of Ca(OH)₂ in the systems.

### Example 4

The kinetics of syneresis in the presence of Mg ions was investigated. Gels were prepared in deionized water that contained 3.6 g/L of guar, 3.6 g/L of H₃BO₃, and 23 ml/L of 5 weight percent NaOH doped with 0.142-1.3 g/L of MgCl₂ and the appropriate quantity of NaOH to create Mg(OH)₂. FIG. 2 shows the syneresis of the borate crosslinked guar gels in samples having different concentrations of Mg(OH)₂ at room temperature. Syneresis started at about 0.005 mol/L of Mg(OH)₂ in the systems.

### Example 5

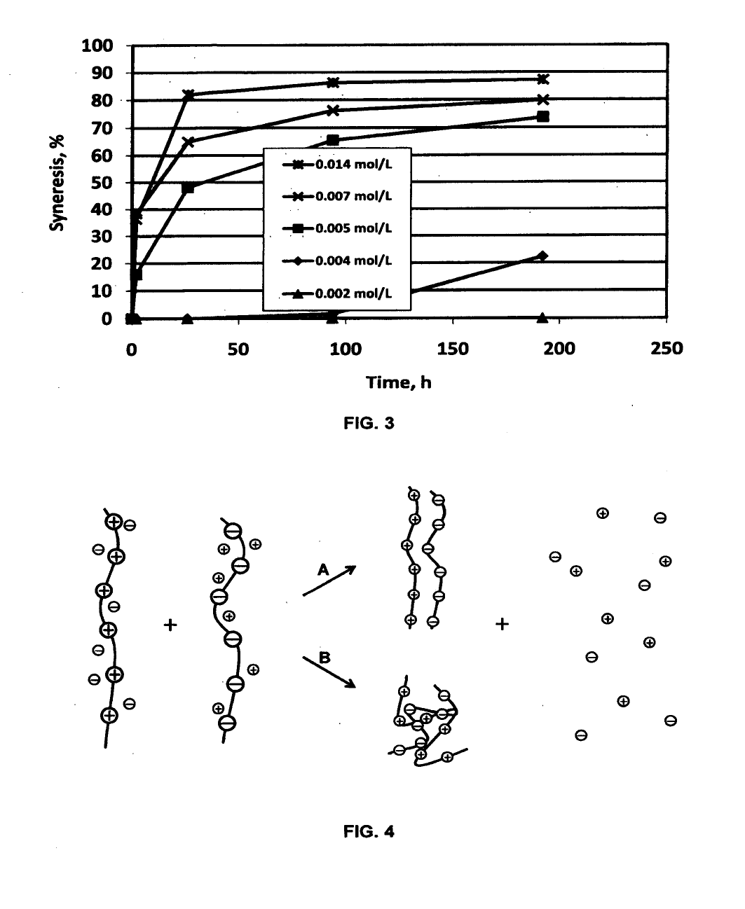

Syneresis kinetics was investigated in the presence of Al ions. Gels were prepared in deionized water that contained 3.6 g/L of guar, 3.6 g/L of H₃BO₃, and 23 ml/L of 5 weight percent NaOH doped with 0.178-3.26 g/L of AlCl_{3*}6H₂O and the corresponding quantity of NaOH to create Al(OH)₃. FIG. 3 shows the syneresis of the borate crosslinked gel samples having varying concentrations of AlCl_{3*}6H₂O. Formation of Al(OH)₄₋ is believed to have occurred; syneresis started at a concentration of about 0.004 mol/L.

### Example 6

Gels with 0.014 mol/L of aluminum (3.6 g/L of guar, 3.6 g/L of H₃BO₃, 3.26 g/L of AlCl_{3*}6H₂O, and 55.4 ml/L of 5 weight percent NaOH) were prepared in deionized water and various amounts of 6-8 mm polylactic acid fiber were added to the samples. Fiber concentrations ranged from 0 to 10.3 g/L. After syneresis, the volume of shrunken gel was a function of the fiber concentration; the more fibers added, the greater the volume of the gel up to about 3.6 g/L fiber. From 3.6 to 10.3 g/L of fiber there was little apparent change in gel syneresis.

### Example 7

The influence of borate crosslinking site density on a syneresis level was examined. Two samples of crosslinked gel with added copper ions were prepared with different concentrations of borate. The first sample was made from 3.6 g/L of guar, 0.652 g/L of CuCl_{2*}2H₂O, 3.6 g/L of H₃BO₃ and 29.1 ml/L of 5 weight percent NaOH in deionized water. The second sample was made from 3.6 g/L of guar, 0.652 g/L of CuCl_{2*}2H₂O, 0.5 g/L H₃BO₃ and 9.1 ml/L of 5 weight percent NaOH in deionized water. After 2 hours at room temperature, the syneresis levels were 70 percent in the sample with high boric acid concentration and 9 percent in the sample with low boric acid content.

### Example 8

Three gm of 0.212-0.106 mm (70/140 mesh) sand (d₅₀ of 169 μm by Malvern Mastersizer analysis) was placed in a Petri dish with 20 ml of deionized water and 0.8 gm of poly(N-isopropylacrylamide) (average Mₙ of about 20,000-25,000); the polymer has an LCST of 32° C. The slurry was mixed vigorously at room temperature for one minute with a magnetic stirrer. No agglomeration was observed. The suspension was then heated to 40° C. while still being stirred. When the temperature reached 40° C., the stirring was stopped and a number of agglomerates were observed. The mean sizes of the agglomerates which formed were estimated by measurement on photographs of the sample bottle laid alongside a graduated scale. The mean size of the agglomerates obtained under dynamic conditions (intensive agitation) was about 0.9 cm. Analysis of the agglomerates showed that they consisted of sand and precipitated polymer.

### Example 9

The use of polyelectrolyte complexes for agglomeration of proppant particles was demonstrated. Agglomeration of 0.850-0.425 mm (20/40 mesh) sand was studied in a polyelectrolyte complex (PEC) formed from partially hydrolyzed polyacrylamide (PHPA) (a random anionic copolymer made from 40 mol percent sodium acrylate and 60 mol percent acrylamide, having an average molecular weight of about 10×10⁶ g/mol) and polyethyleneimine PEI (a highly branched cationic polymer having an average molecular weight of about 8×10⁵ g/mol). A representative structure of the PEI is:

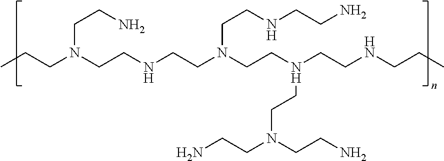

A suspension of 10 g 0.850-0.425 mm (20/40) mesh sand was mixed with 100 g of deionised water in a 250 mL beaker using a flat-two-blade impeller driven at 270 rpm by an overhead mechanical stirrer. With continuous mixing (270 rpm), 25 g of a 1 weight percent PHPA solution (dissolved in 2 weight percent KCl) was added. After a further 10 minutes of continuous mixing, 2.5 g of a 10 weight percent PEI solution (dissolved in deionized water) was added and mixing was continued for 15 minutes. At this point, the aqueous phase of the mixture contained 0.196 weight percent PHPA polymer, 0.196 eight percent PEI polymer and 0.39 weight percent KCl. The pH of the aqueous phase was sufficiently alkaline that the PEI polymer was uncharged, which inhibited precipitation of the PEC. Then acid was added to induce protonation of the PEI polymer and precipitation of the PEC; again with continuous mixing (270 rpm), 2 g of 1 molar HCl was added to the mixture using a Pasteur pipette to introduce the acid solution at the base of the agitating mixture. After a few minutes of continuous mixing, a voluminous and sticky PEC precipitate was formed. After a few more minutes, the PEC precipitate shrank to a small fraction of the total volume and had completely encapsulated (agglomerated) all of the 10 g of sand; there was no residual sand at the bottom of the beaker. The experiment resulted in 100 percent agglomeration efficiency (AE) where AE is defined by the weight percent of the sand encapsulated/agglomerated by the PEC. After acid addition and subsequent thorough mixing, the pH of the aqueous phase was 9.5. At this pH, the PEI was sufficiently protonated (cationic) to interact strongly, by electrostatic attraction, with the anionic carboxylate sites on the PHPA polymer. This resulted in the observed formation of a sticky PEC precipitate. The same 100 percent agglomeration efficiency (AE) of the same sand was achieved in similar experiments with end-point pH's 8.5 and 10.0.

### Example 10

As a further demonstration of agglomeration of 0.850-0.425 mm sand (20/40 mesh), experiments were performed in polyelectrolyte complexes (PEC) formed from the same PEI and PHPA as in Example 9. The experiments were as described for example 9, but this time the ratios of PEI and PHPA were varied and 100 g of 2 weight percent KCl aqueous solution was used in place of the deionized water. As was expected, the higher ionic strength of the 2 weight percent KCl aqueous phase somewhat screened the strong electrostatic interaction between the oppositely charge polymers. The results shown in table 2 were obtained. Again, a high AE was observed even in the presence of salt, but it was not 100%.

TABLE 2

| Aqueous phase | | pH after acid | |
|---|---|---|---|
| composition (before | | addition and | |
| acid addition) | Base fluid | mixing | AE |
| 0.2 wt % PHPA, | 2 wt % KCl | 9.1 | 66 |
| 0.1 wt % PEI | | | |
| 0.2 wt % PHPA, | 2 wt % KCl | 9.2 | 71 |
| 0.2 wt % PEI | | | |
| 0.2 wt % PHPA, | 2 wt % KCl | 9.3 | 80 |
| 0.3 wt % PEI | | | |

It can be seen that there was a slight increase in AE with increasing amounts of PEI.

### Example 11

Agglomeration of 0.850-0.425 mm (20/40 mesh) sand was studied in a polyelectrolyte complex (PEC) formed from borate complexed guar (which is an anionic polymer) and a cationic copolymer of acrylamide and DADMAC. A suspension of 0.850-0.425 mm (20/40 mesh) sand was mixed with 100 g of linear gel that contained 1.2 g/L of guar, 0.46 g/L of boric acid, and 0.1 g/L of the copolymer of acrylamide and DADMAC in a 250 mL beaker using an overhead mixer driven at 500 rpm. The pH of the aqueous phase was approximately neutral. After 5 minutes of continuous mixing, 6 ml/L of 5 weight percent NaOH solution was added, which induced formation of the guar borate complex and PEC precipitation. Essentially all of the sand was in the precipitated phase.

### Example 12

The influence of ionic strength on the level of syneresis was examined. Two samples of crosslinked gel were prepared with different concentration of potassium chloride. The first sample was made from 3.6 g/L of guar, 7 g/L of H₃BO₃ and 42 ml/L of 5 weight percent NaOH in deionized water. The second sample was made from 3.6 g/L of guar, 7 g/L H₃BO₃, 42 ml/L of 5 weight percent NaOH in deionized water, and 20 g/L of KCl. After 2 hours at room temperature, the syneresis levels were 94 percent for the sample with potassium chloride and 0 percent for the sample without the salt.

### Example 13

2 g of the HPC (hydroxy propyl cellulose) thermo-responsive polymer is pre-slurried in a small amount with about 5 ml of hot 50-60° C. water and then diluted with 30 ml of cold deionized (D)I water. 10 g of 30/50 northern white sand is added into the solution, and, while stirring in a glass beaker, the system is heated up to 90° C. (LCST 80° C.). Due to shrinkage of polymer, it is estimated that at least 80 wt % of the sand is bonded into the polymer/sand aggregates.

### Example 14

In a batch mixer, synthetic polymer PNEMAM (poly-N-ethylmethacrylamide) 5 wt % is mixed with guar gum 3 wt % and 100 mesh sand 240 g/I in DI water. The solution is then heated up to 98° C., which leads to shrinkage of the polymer with entrapped sand. When the solution is cooled down, it is estimated that 95 wt % of the entrapped sand is released.

### Example 15

A series of solutions with methyl cellulose CULMINAL MC2000 concentrations ranging from 1-4 wt % are prepared in DI water. It is expected to be confirmed that an increase in polymer loading leads to a decrease in flocculation temperature by 5-15° C. depending on the gel loading. It is expected that, in the case of salts, such as NaCl, AlCl₃ and CaCl₂, a high salt content of >7 wt % will increase the flocculation temperature. The effect is expected to be more pronounced at higher polymer loading, and the flocculation temperature can be raised by 8-15° C.

### Example 16

5% wt. gel of methylcellulose was prepared by dispersing it in 50° C. water in a blender and after that the dispersion was cooled down in a refrigerator for 2-3 hours. The gel represented a sticky and foamy gel. 20 g of 5 wt % methylcellulose solution was mixed with 500 mL of 0.2 wt % fully hydrated guar linear gel. The heterogeneous mixture was heated in a microwave oven to 60° C. (140° F.). As a result of heating, the methylcellulose gel reduced in volume from 100% (at 23° C.) to 53% (at 60° C.).

The same test was performed with a 2 wt % NaCl solution as a base fluid for gel preparation, and the same results were found (the methylcellulose gel reduced in volume from 100% (at 23° C.) to 53% (at 60° C.)). Also, once cooled back down to room temperature (23° C.), the methylcellulose gel became sticky again and expanded to its original volume (100%). The process is thus reversible.

The methylcellulose gel was also pre-mixed with 70/140 sand and then mixed with linear gel. The effect of heating was the same as described above, but the sand was entrapped into solidified methylcellulose clots.

Although only a few example embodiments have been described in detail above, those skilled in the art will readily appreciate that many modifications are possible in the example embodiments without materially departing from the spirit of the disclosure. Accordingly, all such modifications are intended to be included within the scope of this disclosure as defined in the following claims. Accordingly, all such modifications are intended to be included within the scope of this disclosure as defined in the following claims.

What we claim is:

1. A composition comprising:
a carrier fluid including a thermo-responsive polymer;
a proppant; and
optional additives,
wherein the polymer has a low critical solution temperature, wherein
at or below the low critical solution temperature, the polymer is soluble in the composition; and
above the low critical solution temperature, the solubility of the polymer in the composition decreases and the proppant forms aggregates.

2. The composition according to claim 1, wherein the composition consists essentially of the components recited in claim 1.

3. The composition according to claim 1, wherein the composition consists of the components recited in claim 1.

4. The composition according to claim 1, wherein the carrier fluid further includes water.

5. The composition according to claim 4, wherein the carrier fluid further includes a guar or cellulose.

6. The composition according to claim 5, wherein the guar or cellulose is a carboxymethylated guar or carboxymethylated cellulose.

7. The composition according to claim 1, wherein the polymer bears amide groups.

8. The composition according to claim 1, wherein the polymer is selected from the group consisting of ethylene/vinyl alcohol copolymers; ethylene oxide/propylene oxide copolymers; copolymers of N,N-dimethylacrylamide with methyl acrylate, ethyl acrylate, propyl acrylate, butyl acrylate, 2-ethoxyethyl acrylate, and/or 2-methoxyethyl acrylate; hydroxypropyl cellulose; N-isopropylacrylamide/acrylamide copolymers; copolymers of N-isopropylacrylamide with 1-deoxy-1-methacrylamido-D-glucitol; N-isopropylmethacrylamide; methylcellulose; methylcellulose/hydroxypropylcellulose copolymers; polyphosphazene polymers; poly(ethylene glycol); poly(ethylene oxide)-b-poly[bis(methoxyethoxyethoxy)-phosphazene] block copolymers; poly(ethylene oxide)-b-poly(propyleneoxide)-b-poly(ethylene oxide) triblock copolymer; poly(N-isopropylacrylamide); poly(N-isopropylacrylamide)-poly[(N-acetylimino)ethylene] block copolymers; poly(N-isopropylmethacrylamide); poly(propylene glycol); poly(vinyl alcohol); poly(N-vinyl caprolactam); poly(N-vinylisobutyramide); poly(vinyl methyl ether); poly(N-vinyl-N-propylacetamide); N-vinylacetamide/vinyl acetate copolymers; N-vinylcaprolactam/N-vinylamine copolymers; vinyl alcohol/vinyl butyrate copolymers; N-vinylformamide/vinyl acetate copolymers and combinations thereof.

9. The composition according to claim 1, wherein the polymer is selected from the group consisting of methylcellulose and hydroxypropyl cellulose.

10. The composition according to claim 1, wherein the composition further comprises fibers.

11. The composition according to claim 1, wherein the proppant comprises sand.

12. The composition according to claim 1, wherein the additives are present, and the additives comprise at least one salt.

13. A method for forming proppant aggregates, the method comprising:
injecting a slurry that comprises a thermo-responsive polymer having a low critical solution temperature and a proppant into an injection well; and
heating the slurry above the low critical solution temperature of the polymer,
wherein the heating of the slurry above the low critical solution temperature of the polymer aggregates the proppant.

14. The method according to claim 13, wherein the slurry further comprises water.

15. The method according to claim 14, wherein the slurry further comprises a guar or cellulose.

16. The method according to claim 13, wherein the polymer is selected from the group consisting of ethylene/vinyl alcohol copolymers; ethylene oxide/propylene oxide copolymers; copolymers of N,N-dimethylacrylamide with methyl acrylate, ethyl acrylate, propyl acrylate, butyl acrylate, 2-ethoxyethyl acrylate, and/or 2-methoxyethyl acrylate; hydroxypropyl cellulose; N-isopropylacrylamide/acrylamide copolymers; copolymers of N-isopropylacrylamide with 1-deoxy-1-methacrylamido-D-glucitol; N-isopropylmethacrylamide; methylcellulose; methylcellulose/hydroxypropylcellulose copolymers; polyphosphazene polymers; poly(ethylene glycol); poly(ethylene oxide)-b-poly[bis(methoxyethoxyethoxy)-phosphazene] block copolymers; poly(ethylene oxide)-b-poly(propyleneoxide)-b-poly(ethylene oxide) triblock copolymer; poly(N-isopropylacrylamide); poly(N-isopropylacrylamide)-poly[(N-acetylimino)ethylene] block copolymers; poly(N-isopropylmethacrylamide); poly(propylene glycol); poly(vinyl alcohol); poly(N-vinyl caprolactam); poly(N-vinylisobutyramide); poly(vinyl methyl ether); poly(N-vinyl-N-propylacetamide); N-vinylacetamide/vinyl acetate copolymers; N-vinylcaprolactam/N-vinylamine copolymers; vinyl alcohol/vinyl butyrate copolymers; N-vinylformamide/vinyl acetate copolymers and combinations thereof.

17. The method according to claim 13, wherein the polymer is selected from the group consisting of methylcellulose and hydroxypropyl cellulose.

18. The method according to claim 13, wherein the slurry further comprises fibers.

19. The method according to claim 13, wherein the slurry further comprises at least one salt additive.

20. A method for pumping proppant into an injection well, comprising:
forming a slurry that comprises a thermo-responsive polymer having a low critical solution temperature and a proppant;
pumping the slurry into the injection well and downhole; and
subjecting the slurry downhole to a temperature above the low critical solution temperature of the polymer, thereby aggregating the proppant.
